(19) United States
(12) Patent Application Publication
(10) Pub. No.: US 2005/0238915 A1
(43) Pub. Date: Oct. 27, 2005

(54) Organic electroluminescent device

(75) Inventors: Jian Li, Hirakata-city (JP); Takeshi Sano, Hirakata-city (JP); Yasuko Hirayama, Hirakata-city (JP); Taiji Tomita, Neyagawa-city (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/063,609

(22) Filed: Feb. 24, 2005

(30) Foreign Application Priority Data
Feb. 24, 2004 (JP) 2004-48586
Jan. 28, 2005 (JP) 2005-20565

(51) Int. Cl. H05B 33/14

(52) U.S. Cl. 428/690; 428/917; 313/504; 313/506; 257/40

(57) ABSTRACT

An organic electroluminescent device comprising a light emitting layer disposed between a pair of electrodes, wherein the light emitting layer contains a light emitting material, and a host polymer having a first unit interacting with the light emitting material so that energy can be transferred to the light emitting material, and a second unit having a conjugated or non-conjugated structure.

The priority Japanese Patent Application Numbers 2004-48586 and 2005-20565 upon which this patent application is based is hereby incorporated by reference.

### BACKGROUND OF THE INVENTION

1. Field of the Invention

The present invention relates to an organic electroluminescent device.

2. Description of the Related art

Since an organic electroluminescent device is easier in obtaining a large area thereof, generates desired color development by selection of a light emitting material, and can be driven by a low voltage, as compared with an inorganic electroluminescent device, the device is vigorously studied on application in recent years. As a light emitting material used in an organic electroluminescent device, a phosphorescent material which provides light emission from triplet excited state such as an iridium complex is paid an attention because a high emitting efficiency can be expected.

In order to form a light emitting layer using the previously known phosphorescent light emitting material, a method such as a vacuum deposition method is used. However, if a light emitting layer can be formed as a coated film by coating a solution, a step of manufacturing a device can be simplified. For doing so, it is contemplated to use a polymer having film forming ability as a phosphorescent material.

JP-A No.2003-73479 and JP-A No.2003-171659 propose a phosphorescent material having a metal complex structure in a main chain or a side chain of a polymer.

However, since it is necessary to coordinate a polymer as a ligand for a metal complex, there is a problem that it is difficult to prepare it.

### SUMMARY OF THE INVENTION

An object of the present invention is to provide an organic electroluminescent device (organic EL device) using a light emitting polymer material obtained by mixing a light emitting material and a polymer.

The present invention is an organic EL device provided with a light emitting layer disposed between a pair of electrodes, characterized in that the light emitting layer contains a light emitting material, and a host polymer having a first unit having a pyridine ring or a thiophene ring interacting with a light emitting material so that energy can be transferred to a light emitting material, and a second unit having a conjugated or non-conjugated structure.

A light emitting material and a host polymer are contained in the light emitting layer in the present invention, and the host polymer has a first unit having a pyridine ring or a thiophene ring interacting with a light emitting material. For this reason, a light emitting material and a host polymer are interacted, and function as a light emitting substance as a whole. For this reason, only by mixing a light emitting material and a host polymer, this can be used as a light emitting polymer material.

By using a phosphorescent material as a light emitting material, this can be used as a phosphorescent light emitting polymer material which provides efficient light emission from triplet excited state.

In addition, since the light emitting layer in the present invention contains a polymer component, a coated film can be formed by coating a solution. In addition, since a host polymer has a second unit having a conjugated or non-conjugated structure, a light emitting efficiency can be improved by interacting a light emitting material and a host polymer. A conjugated structure in a second unit may be not only a conjugated structure in a second unit, but also a conjugated structure formed between a first unit and the second unit.

It is preferable that a second unit in the present invention has a structure having carrier transport property. In the case of a non-conjugated structure, carrier transport property can be imparted by possession of π bond and the like in its side chain.

A host polymer in the present invention may further contain a third unit. It is preferable that a third unit is a unit having carrier transport property. In particular, in the case of only a first unit and a second unit, unbalance occurs in carrier transport properties for electron and hole in some cases, and it is preferable that a third unit having such the carrier transport property that this is compensated for in such the case, is disposed. That is, it is preferable that a third unit has carrier transport property for taking balance for carrier transport properties of a first unit and/or a second unit.

For example, when pyridine or a derivative thereof is used as a first unit, and fluorene or a derivative thereof is used as a second unit, it is preferable to use a unit having hole transport property such as a phenylamine-containing compound or a carbazole derivative as a third unit. The reason is as follows: since a conjugation system of pyridine which is a first unit has electron transport property, and a conjugation system of fluorene which is a second unit has bipolar property (i.e. hole transport property+electron transport property) and, therefore, hole transport property is deficient as a whole, it becomes necessary to take a whole carrier balance by imparting a third unit having hole transport property.

In an organic electroluminescent device, an exciton is generated by recombination of a hole and an electron, and light emission is obtained in a process during which an exciton is relaxed to the base state. For this reason, it is necessary to inject a hole and an electron into a light emitting layer in a better balance to effectively recombine them. When unbalance is caused in an amount of a hole and an electron in carrier injection or carrier transport, or when recombination is performed outside a light emitting layer, light emission can not be obtained at a high efficiency. Therefore, in order to manufacture a device having a highly emitting efficiency, it is necessary to form a laminated structure such as hole transport layer/light emitting layer/electron transport layer, or set a material and a mixing ratio so that balance between a hole and an electron can be taken in a light emitting layer. In a host polymer in the present invention, since a unit having hole transport property and electron transport property can be disposed in each unit, a ratio of blending these units having carrier transport property can be controlled. Therefore, usually, an optimal carrier balance can be realized, and a high emitting efficiency can be obtained.

As a construction of a host polymer, for example, interacting unit+electron transport unit+hole transport unit may be used, or interacting unit+bipolar unit+hole transport unit, or interacting unit+bipolar unit+electron transport unit may be used. Depending on a device structure or lamination state, at least one unit among first, second and third units may be set at a plural number, such as interacting unit+hole transport unit 1+hole transport unit 2.

When a unit having a thiophene ring is used as an interacting unit (first unit), since hole transport property can be expected in conjugated thiophene, carrier balance is relatively easily taken in a copolymer with polyfluorene having bipolar property. In this case, by inclusion of a unit having a structure of a phenylamine derivative having hole transport property as a third unit, optimization can be performed.

As an interacting unit (first unit), a unit having a structure of pyridine or a pyridine derivative, or thiophene or a thiophene derivative having a lone electron pair is preferable. In addition, as a hole transport unit, a unit having a structure of phenylamine or a phenylamine derivative, or carbazole or a carbazole derivative may be used, being not limiting. As an electron transport unit, a unit having a structure of oxadiazole or an oxadiazole derivative, or a heterocyclic compound having a nitrogen atom such as pyridine, quinoline, and quinoxaline, or a derivative thereof maybe used, being not limiting.

A light emitting material used in the present invention is not particularly limited as long as it is a light emitting material which can interact with a first unit of a host polymer, but a metal complex is preferably used. Examples of a metal complex include an Ir (iridium) complex, a Pt (platinum) complex, and an Os (osmium) complex. Among these metal complexes, there are many complexes which are known as a metal complex of triplet excitation light emission. In addition, as the metal complex, an Al (aluminum) complex and a Zn (zinc) complex may be used. Among these metal complexes, there are many complexes which are known as a metal complex of singlet excitation light emission, and light emission from a metal complex is effectively obtained by interaction with a host polymer.

Interaction between a light emitting material and a host polymer in the present invention will be explained using a host polymer (PF8-Py) used in Example 1, and an Ir complex (btp₂Ir(acac)) as a light emitting material as an example. A PF8-Py polymer is an alternate copolymer having a structure shown below.

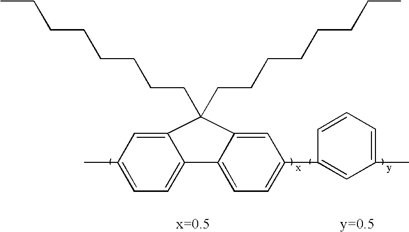

It is contemplated that, when btp₂Ir (acac) as an Ir complex is mixed with a PF8-Py polymer, the following interaction is occurred between a PF8-Py polymer which is a host polymer, and an Ir complex.

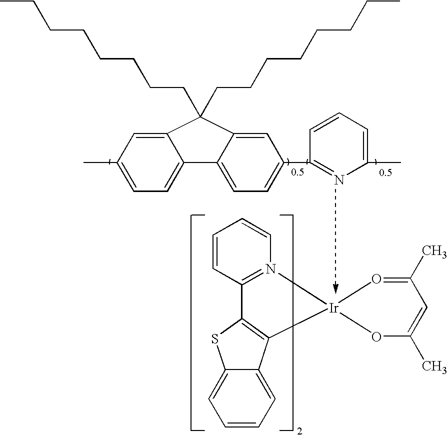

It is contemplated that, by coordination-like action of a metal Ir of an Ir complex with a lone electron pair of nitrogen on a pyridine ring of a PF8-Py polymer as shown above, interaction is occurred between a PF8-Py polymer and an Ir complex. As a result of such the interaction, it is contemplated that a host polymer and a light emitting material become to function as a light emitting substance as a whole.

A second unit of a PF8-Py polymer has a fluorene structure. Examples of a fluorene structure in a second unit of a host polymer in the present invention include the following fluorene structure. 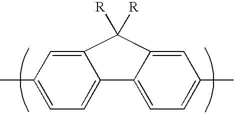
(wherein R is an alkyl group of a carbon number of 1 to 20, or an alkyl group of a carbon number of 1 to 20 containing or combining with O, S, N, F, P, Si or an aryl group in part thereof) 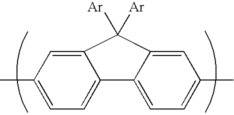
(wherein Ar is the following aryl group) 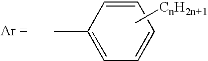
(wherein CₙH₂ₙ₊₁ is an alkyl group of a carbon number of 1 to 20, or an alkyl group of a carbon number of 1 to 20 containing or combining with O, S, N, F, P, Si or an aryl group in part thereof) 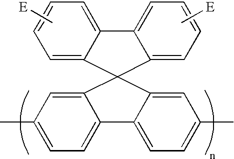
(wherein E is an alkyl group, an aryl group, a phenylamine group, an oxadiazole group, or a thiophene group, an alkyl group is the aforementioned alkyl group R of a carbon number of 1 to 20, and an aryl group is the aforementioned Ar)

In the forgoing, a carbon number of an alkyl group is 1 to 20, because when a carbon number is less than 1, a host polymer is poorly dissolved in a solvent and, when a carbon number exceeds 20, carrier transport property of a host polymer is reduced.

A weight average molecular weight (Mw) of a host polymer in the present invention is in a range of preferably 500 to 10,000,000, further preferably 1,000 to 5,000,000, particularly preferably 5,000 to 2,000,000. When a molecular weight is too low, property as a polymer (film forming ability) is lost and, when a molecular weight is too high, a polymer is poorly dissolved in a solvent.

In the present invention, it is preferable that a ratio of a light emitting material and a host polymer to be mixed is 50% by weight or less as expressed by a ratio of mixing a light emitting material relative to a host polymer. That is, it is preferable that a light emitting material is 50 parts by weight or less relative to 100 parts by weight of a host polymer. A ratio of mixing a light emitting material relative to a host polymer is further preferably 0.1 to 20% by weight, further preferably 0.5 to 15% by weight. When a ratio of a light emitting material is outside the aforementioned range, there is a tendency that an emitting efficiency is decreased.

In the present invention, a carrier transport material for improving carrier transport property may be further contained in a light emitting layer. By inclusion of a carrier transport material, carrier transport property in a light emitting layer can be improved. When a host polymer has electron transport property, it is preferable to use a material having hole transport property as such the carrier transport material. In addition, when a host polymer has hole transport property, it is preferable to use an electron transport material.

A ratio of mixing a carrier transport material is preferably 200% by weight or less, further preferably 1 to 100% by weight, further preferably 10 to 50% by weight as expressed by a ratio of a carrier transport material relative to a host polymer. When a carrier transport material is too small, effect of improving carrier transport property is not sufficiently obtained in some cases and, when a carrier transport material is too much, there is a possibility that an emitting efficiency is decreased.

A light emitting layer in the present invention can be formed as a coated film by coating a solution in which a light emitting material, a host polymer and, if necessary, a carrier transport material are dissolved.

In the present invention, a host polymer interacting with a light emitting material is contained in a light emitting layer, and a light emitting polymer material can be obtained by mixing a light emitting material and a host polymer. Therefore, a light emitting polymer material can be obtained by simple mixing. By using a host polymer interacting with a light emitting material, a driving voltage can be reduced, and an emitting efficiency can be enhanced. Therefore, according to the present invention, a light emitting layer having a low driving voltage and a high emitting efficiency can be formed as a coated film by coating a solution.

### BRIEF DESCRIPTION OF THE DRAWINGS

FIG. 1 is a view showing a photoluminescence (PL) spectrum of a polymer thin film of Example 1 and a polymer 1 in accordance with the present invention.

FIG. 2 is a view showing a photoluminescence (PL) spectrum of a polymer thin film of Comparative Example 1 and a polymer 2.

FIG. 3 is a schematic cross-sectional view showing a structure of a single layer device manufactured in Example of the present invention.

FIG. 4 is a schematic cross-sectional view showing a structure of a multilayered device manufactured in Example of the present invention.

### DESCRIPTION OF PREFERRED EXAMPLES

The present invention will be explained in detail below by way of Examples, but the present invention is not limited by the following Examples, and can be practiced with appropriate alternation.

### PREPARATION EXAMPLE 1

### Preparation of poly[(9,9-dioctylfluorene-2,7-diyl)-alt-(pyridine-2,6-diyl)][polymer 1](PF8-Py)>

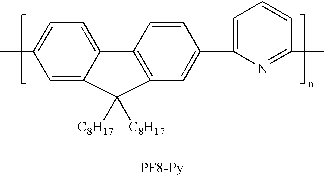

2,6-dibromopyridine (118.5 mg, 0.5 mmol), 9,9-dioctylfluorene-2,7-bis(4,4,5,5-tetramethyl-1,3,2-dioxa borolane (321 mg, 0.5 mmol), Suzuki coupling catalyst, 5 ml of toluene, and 8 ml of an aqueous basic solution were added to a reactor equipped with a stirrer, a rubber septa and an inlet to a vacuum and nitrogen manifold. The reactor was evacuated, purged with nitrogen three times, and then heated to 90° C. Under the nitrogen atmosphere, the reaction solution was retained at 90° C. for about 3 hours. Then, 61 mg (0.5 mmol) of phenylboric acid was added, and the reactor was further retained at 90° C. for 2 hours under the nitrogen atmosphere. Thereafter, about 0.12 ml (1.1 mmol) of bromobenzene was added, and the reaction solution was retained at 90° C. for 2 hours under the nitrogen atmosphere. Then, in order to precipitate a polymer, the reaction mixture was poured into 300 ml of methanol, and washed with methanol three times. After dried under vacuum, the polymer was dissolved in about 10 ml of toluene, and this was purified by a column using toluene as an eluent. After a part of the solvent was removed by a rotary evaporator, the polymer solution was added to 300 ml of methanol to obtain precipitates, which were washed with methanol three times. Drying under vacuum afforded a white powder product. A yield was about 80%. A number average molecular weight (Mn) was 5.2×10⁴, a weight average molecular weight (Mw) was 1.1×10⁵, and Mw/Mn was 2.16.

### COMPARATIVE PREPARATION EXAMPLE 1

### Preparation of poly(9,9-dioctylfluorene-2,7-diyl)[polymer 2](PF8)

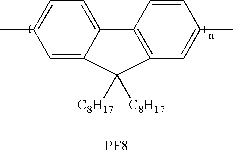

9,9-dioctylfluorene-2,7-dibromide (274 mg, 0.5 mmol), 9.9-dioctylfluorene-2,7-bis(4,4,5,5-tetramethyl-1,3,2-dioxa borolane (321 mg, 0.5 mmol), Suzuki coupling catalyst, 5 ml of toluene, and 8 ml of an aqueous basic solution were added to a reactor equipped with a stirrer, a rubber septa, and an inlet to a vacuum and nitrogen manifold. The reactor was evacuated, purged with nitrogen three times, and then heated to 90° C. Under the nitrogen atmosphere, the reaction solution was retained at 90° C. for about 3 hours. Then, 61 mg (0.5 mmol) of phenylboric acid was added, and the reactor was further retained at 90° C. for 2 hours under the nitrogen atmosphere. Thereafter, about 0.12 ml (1.1 mmol) of bromobenzene was added, and the reaction solution was retained at 90° C. for 2 hours under the nitrogen atmosphere. Then, in order to precipitate a polymer, the reaction mixture was poured into 300 ml of methanol, and washed with methanol three times. After dried under vacuum, the polymer was dissolved in about 10 ml of toluene, and this was purified by a column using toluene as an eluent. A part of the solvent was removed by a rotary evaporator, and the polymer solution was added to 300 ml of methanol to obtain precipitates, which were thereafter washed with methanol three times. Drying under vacuum afforded a white powder product. A yield was about 86%. A number average molecular weight (Mn) was 1.4×10⁵, a weight average molecular weight (Mw) was 4.4×10⁵, and Mw/Mn was 3.23.

### PREPARATION EXAMPLE 2

### Preparation of poly[(9,9-dioctylfluorene-2,7-diyl)-co-(pyridine-2,6-diyl)(30%)-co-(N-butylcarbazole-3,6-diyl)(20%)][polymer 3](PF8-Py-Cz)

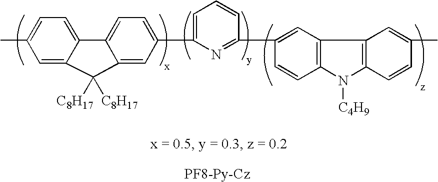

2,6-dibromopyrridine (71.1 mg, 0.3 mmol), N-butyl-3,6′-dibromocarbazole (76.2 mg, 0.2 mmol), 9,9-dioctylfluorene-2,7-bis(4,4,5,5-tetramethyl-1,3,2-dioxa borolane (321 mg, 0.5 mmol), Suzuki coupling catalyst, 5 ml of toluene, and 8 ml of an aqueous basic solution were added to a reactor equipped with a stirrer, a rubber septa, and an inlet to a vacuum and nitrogen manifold. The reactor was evacuated, purged with nitrogen three times, and then heated to 90° C. The reaction solution was retained at 90° C. for about 3 hours under the nitrogen atmosphere. Then, 61 mg (0.5 mmol) of phenylboric acid was added, and the reactor was further retained at 90° C. for 2 hours under the nitrogen atmosphere. Thereafter, about 0.12 ml (1.1 mmol) of bromobenzene was added, and the reaction solution was retained at 90° C. for 2 hours under the nitrogen atmosphere. Then, in order to precipitate a polymer, the reaction mixture was poured into 300 ml of methanol, and this was washed with methanol three times. After dried under vacuum, the polymer was dissolved in about 10 ml of toluene, and this was purified by a column using toluene as an eluent. After a part of the solvent was removed by a rotary evaporator, the polymer solution was added to 300 ml of methanol to precipitate it and, thereafter, this was washed with methanol three times. Drying under vacuum afforded a white powder product. A yield was about 80%. A number average molecular weight (Mn) was 4.3×10⁴, a weight average molecular weight (Mw) was 1.2×10⁵, and Mw/Mn was 2.78.

### EXAMPLE 1

### Preparation of Polymer Thin Film

Using an iridium complex [bis(2-(2′-benzothienyl)pyridinato-N,C³′) iridium (III) (acetylacetonate) :btp₂Ir (acac)] having the following structure, a polymer film was prepared as follows:

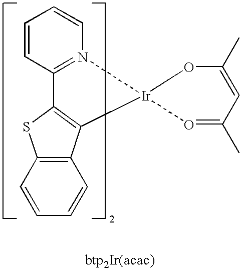

A polymer 1 (20 mg), btp₂Ir (acac) (2 mg) and a chloroform-xylene mixed solvent (1 ml:2 ml) were added to a reactor equipped with a stirrer, a rubber septa, and an inlet to a vacuum and nitrogen manifold. This solution was stirred at room temperature for a few minutes under the nitrogen atmosphere to obtain a transparent red polymer solution (PF8-Py-Ir solution).

This polymer solution was spin-coated on a glass substrate to prepare a polymer thin film (polymer-metal complex thin film).

### COMPARATIVE EXAMPLE 1

### Preparation of Comparative Polymer Thin Film

A polymer 2 was used in place of a polymer 1 in Example 1 to prepare a PF8-Ir solution, and this solution was used to prepare a polymer film in the same manner as that of Example 1.

<Measurement of Photoluminescense (PL) Spectrum of Polymer Thin Film>

Regarding the PF8-Py-Ir thin film obtained in Example 1 and the PF8-Ir thin film obtained in Comparative Example 1, a PL spectrum was measured. A PL spectrum was measured using a fluorescent spectrophotometer F-4500 manufactured by Hitachi, Ltd.

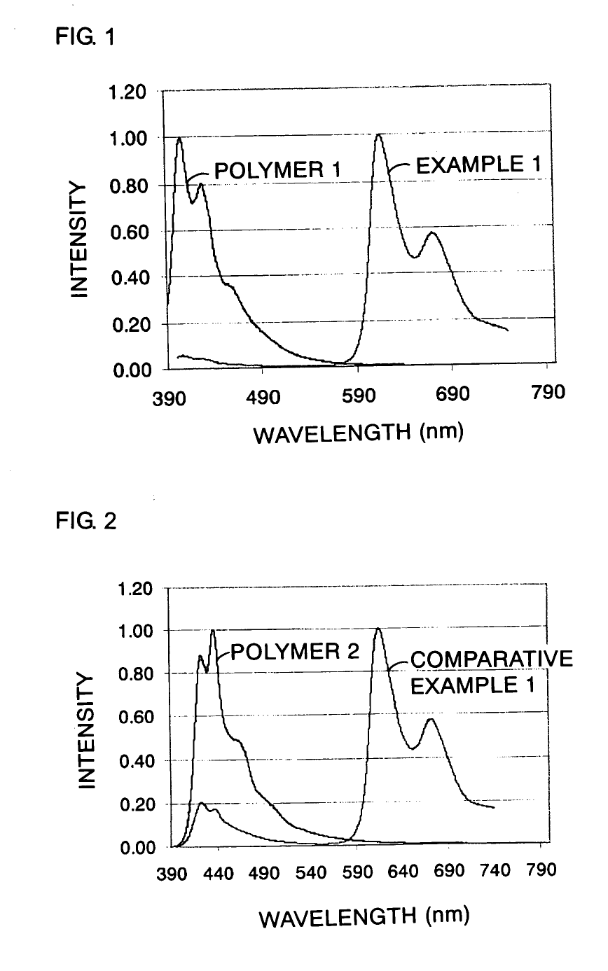

FIG. 1 shows a PL spectrum of the PF8-Py-Ir thin film (Example 1) and the polymer 1. FIG. 2 shows a PL spectrum of the PF8-Ir film thin (Comparative Example 1) and the polymer 2.

As apparent from FIG. 1, a PL spectrum of the PF8-Py-Ir thin film (Example 1) shows a strong peak around 618 nm and 675 nm. This is based on btp₂Ir(acac) which is an Ir complex. A blue fluorescent light based on the polymer 1 which is a host polymer was not recognized in the PF8-Py-Ir thin film (Example 1).

On the other hand, as apparent from FIG. 2, a PL spectrum of the PF8-Ir thin film (Comparative Example 1) shows peaks at 618 nm and 675 nm and, at the same time, shows peaks at 428 nm and 441 nm based on a PF8 matrix. In the PF8-Py-Ir film (Example 1), effective energy transfer from a host polymer to an iridium complex is recognized. However, in the PF8-Ir film (Comparative Example 1), energy transfer is not effective. This is contemplated that a Py (pyridine) unit in a PF8-Py polymer (Example 1) very effectively contributes to energy transfer. It is contemplated that a lone electron pair of a pyridine unit has some interaction with an iridium complex. The previous PF8 polymer has no lone electron pair and, therefore, it is contemplated that better interaction is not shown between a host polymer and an iridium complex.

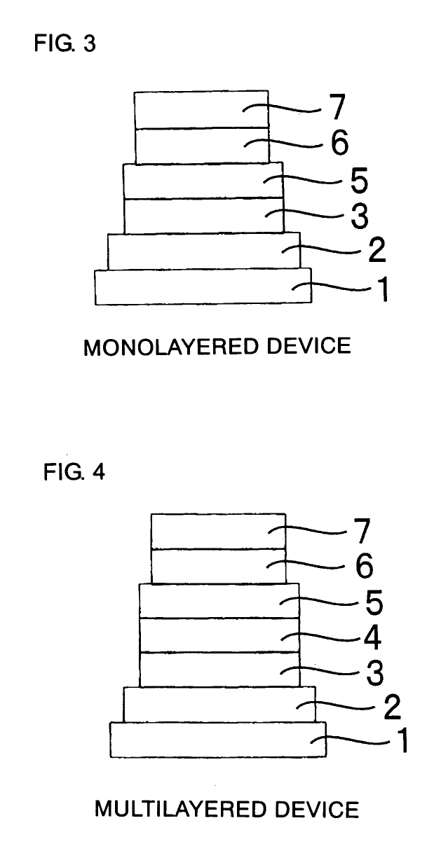

In the following Examples, a “monolayered device” shows an organic EL device having a structure shown in FIG. 3. In this device, as shown in FIG. 3, a transparent electrode (ITO) 2 is formed on a glass substrate 1, and a hole injection layer (HIL) 3 consisting of PEDOT:PSS is formed thereon. A light emitting layer (EML) 5 is disposed thereon. An electron injection layer (EIL) 6 consisting of Ca or LiF/Ca is disposed on the light emitting layer 5, and an electrode 7 consisting of Al is disposed thereon.

In addition, in the following Examples, a “multilayered device” shows an organic EL device having a structure shown in FIG. 4. As shown in FIG. 4, the multilayered device is the same as the monolayered device shown in FIG. 3 except that a hole transport layer (HTL) 4 is disposed between a hole injection layer 3 and a light emitting layer 5.

### EXAMPLE 2

### Red Monolayered Element 1

An ITO-glass substrate used in preparation of a device was washed with ion-exchanged water, 2-propanol and acetone, and then treated with an ozone gas under UV light. Poly(ethylenedioxythiophene):poly(styrenesulfonate) (hereinafter, referred to as PEDOT: PSS) (manufactured by Bayer) was spin-coated on this ITO substrate. A thickness of PEDOT:PSS thin film (PEDOT thin film) was controlled at about 500 Å. This PEDOT thin film was heated at about 200° C. for about 10 minutes in the air, and then heated at 80° C. for about 30 minutes in vacuum. Then, the PF8-Py-Ir solution was spin-coated on the PEDOT layer. A thickness of this light emitting layer was controlled at about 800 Å. Then, calcium and aluminum used as a cathode were sedimented on this. A thickness was 50 Å and 2000 Å, respectively. Then, this substrate was sealed with a cover glass in a glove box purged with dry nitrogen to obtain a device. This device emitted a dense red color from an Ir complex. A CIE color coordinate was (x:0.67, y:0.32) at 100 cd/m². A driving voltage was about 32V at 10 cd/m², a maximum luminance was about 123 cd/m² at 38V, and a maximum efficiency was 1.14 cd/A at 123 cd/m².

PEDOT: PSS has the following structure.

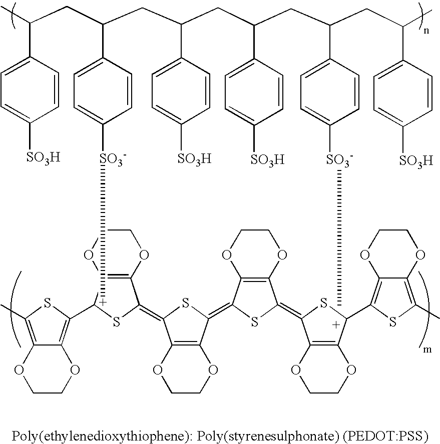

### EXAMPLE 3

### Red Monolayered Device 2

A red monolayered device 2 was prepared in the same manner as that of Example 2 except that a light emitting layer was formed from a solution of a polymer 1 (PF8-Py) (20 mg), btp₂Ir(acac) (2 mg), and N,N′-bis (3-methylphenyl)-N,N′-diphenylbenzidine (TPD) (4 mg) in a chloroform-xylene (1 ml:2 ml) by spin coating.

This device emitted a dense red color from an Ir complex. A CIE color coordinate was (x:0.67, y:0.32) at 500 cd/m². A driving voltage at 10 cd/m² was about 6V. A maximum emitting amount was 1688 cd/m² at 12V. A maximum efficiency was about 1.92 cd/A at 9.0V and 473 cd/m².

TPD has the following structure.

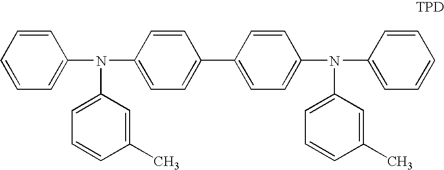

### COMPARATIVE EXAMPLE 2

### Red Monolayered Device 3

A red monolayered device 3 was prepared in the same manner as that of Example 2 except that a light emitting layer was formed from a polymer 2 (PF8) (20 mg), btp₂Ir(acac) (2 mg), and N,N′-bis(3-methylphenyl)-N,N′-diphenylbenzidine (TPD) (4 mg).

This device emitted a red color from an Ir complex and a slight color from PF8. A CIE color coordinate was (x:0.67, y:0.31) at 500 cd/m². A driving voltage at 10 cd/m² was about 7V. A maximum luminance was 998 cd/m² at 11.5V. A maximum efficiency was about 0.9 cd/A at 10V and 412 cd/m².

From comparison of a red monolayered device 2 and a red monolayered device 3, it is seen that a red monolayered device 2 of the present invention having a host polymer having a pyridine unit in a main chain of a polymer shows better tone, and shows a higher emitting efficiency and luminance.

### EXAMPLE 4

### Red Monolayered Device 4

A red monolayered device 4 was prepared in the same manner as that of Example 2 except that a light emitting layer was formed from a polymer 3 (PF8-Py-Cz) (20 mg), btp₂Ir(acac) (2 mg), and N,N′-bis(3-methylphenyl)-N,N′-diphenylbenzidine (TPD) (4 mg).

This device emitted a dense red color from an Ir complex. A CIE color coordinate was (x:0.67, y:0.32) at 500 cd/m². A driving voltage at 10 cd/m² was about 6V. A maximum emitting amount was 1598 cd/m² at 12V. A maximum efficiency was about 1.95 cd/A at 8.5V and 150 cd/m².

### EXAMPLE 5

### Red Multilayered Device 5

An ITO-glass substrate used in preparation of a device was washed with ion-exchange water, 2-propanol and acetone, and treated with an ozone gas under UV light. PEDOT:PSS (manufactured by Bayern) was spin-coated on this ITO substrate. A thickness of a PEDOT:PSS thin film (PEDOT thin film) was controlled at about 500 Å. This PEDOT thin film was heated at about 200° C. for about 10 minutes in the air, and then heated at 80° C. for about 30 minutes in vacuum. Then, a polymer solution containing poly{(9,9-dioctylfluorene-2,7-diyl)-alt-(triphenylamine-4,4′-diyl)}(PF8-TPA) (20 mg), a crosslinking agent (1,4-butanediol dimethacrylate)(BDMA) (12 mg), a photoinitiator (benzoinethyl ether) (0.6 mg) and toluene (5 ml) was spin-coated on a PEDOT layer, and crosslinked by UV light (4 mW/cm², 5 min) to form HTL (hole transport layer). A thickness of an HTL layer was controlled at about 240 Å. Then, a mixed solution of a polymer and an Ir complex was spin-coated on an HTL layer. This mixed solution is obtained by dissolving a polymer 1 (PF8-Py) (20 mg), btp₂Ir(acac) (2 mg) and TPD (4 mg) in 2 ml of a chloroform-xylene mixed solvent. A thickness of this light emitting layer was controlled at about 800 Å. Then, calcium and aluminum used as a cathode were sedimented on this layer. A thickness was 50 Å and 2,000 Å, respectively. Then, this substrate was sealed with a cover glass in a glove box purged with dry nitrogen, to obtain a device. This device emitted a dense red color from an Ir complex. A CIE color coordinate was (x:0.68, y:0.32) at 500 cd/m². A driving voltage was about 5.5V at 10 cd/m², a maximum emitting amount was about 2562 cd/m² at 13V, and a maximum efficiency was about 3.78 cd/A at 8.5V and 388 cd/m².

Structures of PF8-TPA, BDMA, and benzoinethyl ether are shown below.

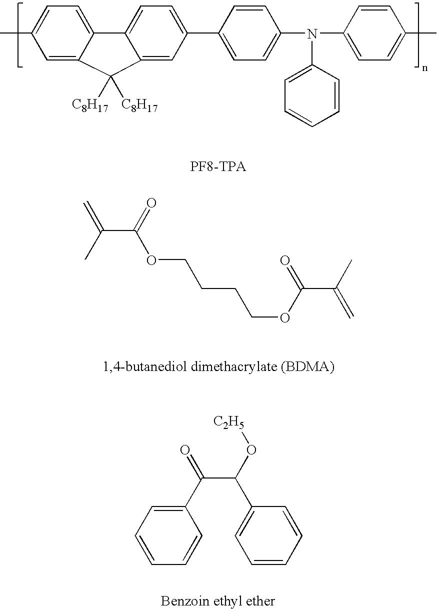

### EXAMPLE 6

### Green Monolayered Device 1

A green monolayered device 1 was prepared in the same manner as that of Example 3 except that a light emitting layer was formed from a polymer 1 (PF8-Py) (20 mg), bis(10-hydroxybenzo[h]quinolinato) beryllium (BeBq₂) (2 mg) and TPD (4 mg).

This device emitted a green color from a BeBq₂ complex. A driving voltage at 10 cd/m² was about 13V. A maximum luminance was 336 cd/m² at 19.5V. A maximum efficiency was about 0.17 cd/A at 13.5V and 19 cd/m².

A structure of BeBq₂ is shown below.

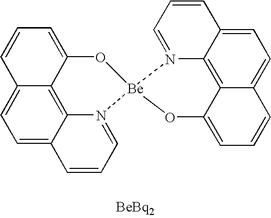

### EXAMPLE 7

### Green Multilayered Device 2

A green multilayered device 2 was prepared in the same manner as that of Example 5 except that a light emitting layer was formed from a polymer 1 (PF8-Py) (20 mg), a BeBq₂ complex (2 mg) and TPD (4 mg).

This device emitted a green color from a BeBq₂ complex. A driving voltage at 10 cd/m² was about 12.5V. A maximum luminance was 2550 cd/m² at 21V. A maximum efficiency was about 0.54 cd/A at 13.5V and 19 cd/m².

### COMPARATIVE EXAMPLE 3

### Green Monolayered Device 3

A green monolayered device 3 was prepared in the same manner as that of Comparative Example 2 except that a light emitting layer was formed from a polymer 2 (PF8) (20 mg), a BeBq₂ complex (2 mg) and TPD (4 mg).

This device emitted a blue-green color from PF8 and a BeBq₂ complex. A driving voltage at 10 cd/m² was about 14V. A maximum luminance was 33 cd/m² at 23V. A maximum efficiency was about 0.12 cd/A at 14V and 10 cd/m².

### EXAMPLE 8

### Blue Monolayered Device 1

A blue monolayered device 1 was prepared in the same manner as that of Example 2 except that a light emitting layer was formed from a polymer 1 (PF8-Py) (20 mg), and bis(2-methyliminomethyl-phenolato)zinc (II)(2AZM-Me) (2 mg).

This device emitted a blue color from a 2AZM-Me complex. A CIE color coordinate was (x:0.19, y:0.16) at 40 cd/m². A driving voltage at 10 cd/m² was about 9V. A maximum luminance was 43 cd/m² at 11.5V. A maximum efficiency was about 0.096 cd/A at 8.5V and 8.5 cd/m².

A structure of 2AZM-Me is shown below.

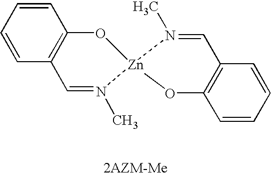

### EXAMPLE 9

### Blue Monolayered Device 2

A blue monolayered device 2 was prepared in the same manner as that of Example 3 except that a light emitting layer was formed from a polymer 1 (TF8-Py) (20 mg), 2AZM-Me (2 mg) and TPD (4 mg).

This device emitted a blue color from a 2AZM-Me complex. A driving voltage at 10 cd/m² was about 9V. A maximum luminance was 269 cd/m² at 15.0V. A maximum efficiency was about 0.124 cd/A at 9.5V and 18 cd/m².

### EXAMPLE 10

### Blue Monolayered Device 3

A blue monolayered device 3 was prepared in the same manner as that of Example 2 except that a light emitting layer was formed from a polymer 3(PF8-Py-Cz) (20 mg) and 2AZM-Me (2 mg).

This device emitted a blue color from a 2AZM-Me complex. A driving voltage at 10 cd/M² was about 5.5V. A maximum luminance was 339 cd/m² at 0.5V. A maximum efficiency was about 0.22 cd/A at 6.5V and 84 cd/m².

### EXAMPLE 11

### Blue Multilayered Device 4

A blue multilayered device 4 was prepared in the same manner as that of Example 5 except that a light emitting layer was formed from a polymer 1 (PF8-Py) (20 mg), 2AZM-Me (2 mg) and TPD (4 mg).

This device emitted a blue color from a 2AZM-Me complex. A driving voltage at 10 cd/m² was about 9.5V. A maximum luminance was 802 cd/m² at 17V.

A maximum efficiency was about 0.35 cd/A at 14.5V and 376 cd/m².

### Comparative Example 4

### Blue Monolayered Device 5

In the same manner as that of Comparative Example 2 except that a light emitting layer was formed from a polymer 2 (PF8) (20 mg), 2AZM-Me (2 mg) and TPD (4 mg), a blue monolayered device 5 was prepared.

This device emitted a blue color from PF8 and a 2AZM-Me complex. A driving voltage at 10 cd/m² was about 20V. A maximum luminance was 15 cd/m² at 25V. A maximum efficiency was about 0.09 cd/A at 20V and 10 cd/m².

A maximum luminance and a maximum efficiency in the above devices of Examples 2 to 11 and Comparative Examples 2 to 4 are shown in Table 1 to Table 3.

TABLE 1

| | | | Carrier | | | |
|---|---|---|---|---|---|---|
| Red Emitting | | Metal | Transport | Device | Maximum | Maximum |
| Device | Polymer | Complex | Material | Structure | Luminance | Efficiency |
| Example 2 | PF8-Py | btp₂lr(acac) | — | Monolayered | 123 cd/m² | 1.14 cd/A |
| | | | | Device | | |
| Example 3 | PF8-Py | btp₂lr(acac) | TPD | Monolayered | 1688 cd/m² | 1.92 cd/A |
| | | | | Device | | |
| Comparative | PF8 | btp₂lr(acac) | TPD | Monolayered | 998 cd/m² | 0.9 cd/A |
| Example 2 | | | | Device | | |
| Example 4 | PF8-Py-Cz | btp₂lr(acac) | TPD | Monolayered | 1598 cd/m² | 1.95 cd/A |
| | | | | Device | | |
| Example 5 | PF8-Py | btp₂lr(acac) | TPD | Multilayered | 2562 cd/m² | 3.78 cd/A |
| | | | | Device | | |

TABLE 2

| | | | Carrier | | | |
|---|---|---|---|---|---|---|
| Green Emitting | | Metal | Transport | Device | Maximum | Maximum |
| Device | Polymer | Complex | Material | Structure | Luminance | Efficiency |
| Example 6 | PF8-Py | BeBq₂ | TPD | Monolayered | 336 cd/m² | 0.17 cd/A |
| | | | | Device | | |
| Example 7 | PF8-Py | BeBq₂ | TPD | Multilayered | 2550 cd/m² | 0.54 cd/A |
| | | | | Device | | |
| Comparative | PF8 | BeBq₂ | TPD | Monolayered | 33 cd/m² | 0.12 cd/A |
| Example 3 | | | | Device | | |

TABLE 3

| | | | Carrier | | | |
|---|---|---|---|---|---|---|
| Blue Emitting | | Metal | Transport | Device | Maximum | Maximum |
| Device | Polymer | Complex | Material | Structure | Luminance | Efficiency |
| Example 8 | PF8-Py | 2AZM-Me | — | Monolayered | 43 cd/m² | 0.096 cd/A |
| | | | | Device | | |
| Example 9 | PF8-Py | 2AZM-Me | TPD | Monolayered | 269 cd/m² | 0.124 cd/A |
| | | | | Device | | |
| Example 10 | PF8-Py-Cz | 2AZM-Me | — | Monolayered | 339 cd/m² | 0.22 cd/A |
| | | | | Device | | |
| Example 11 | PF8-Py | 2AZM-Me | TPD | Multilayered | 802 cd/m² | 0.35 cd/A |
| | | | | Device | | |
| Comparative | PF8 | 2AZM-Me | TPD | Monolayered | 15 cd/m² | 0.09 cd/A |
| Example 4 | | | | Device | | |

As apparent from results shown in Table 1 to Table 3, light emitting devices of Examples 2 to 11 in accordance with the present invention show a higher luminance and a higher light emitting efficiency as compared with light emitting devices of Comparative Examples 2 to 4.

A host polymer and a light emitting material in the present invention are not limited to those shown in the aforementioned Examples, but various host polymers and light emitting materials can be used. For examples, as a red emitting material, PtOEP having the following structure can be used.

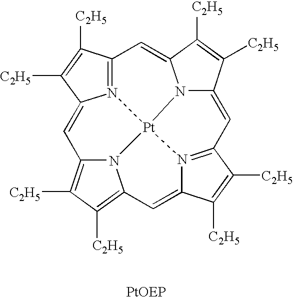

In addition, as a green emitting material, Alq3 having the following structure can be used.

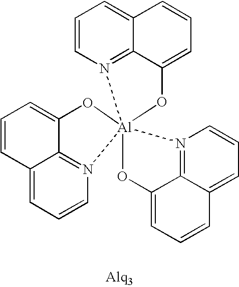

In addition, as a blue emitting material, BAlq having the following structure can be used.

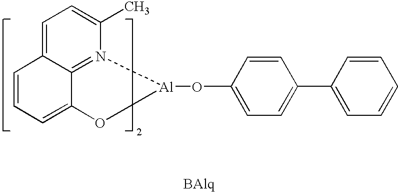

In addition, as a light emitting material, a compound having the following general formula can be used. 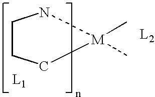
(wherein N: nitrogen, C: carbon, L₁: ligand, L₂: ligand 2, M: metal ion, n=1 or 2, and L₁ and L₂ may be the same or different)

More specifically, the following light emitting materials can be used. 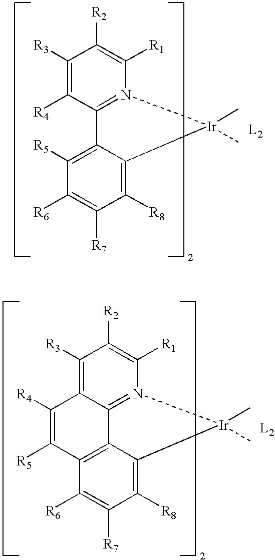
(wherein R₁ to R₈ are any of H, F, CF₃, CₙH₂ₙ₊₁ (n=1 to 10), OCₙH₂ₙ₊₁ (n=1 to 10), C₆H₅, C6H₄CₙH₂ₙ₊₁, a hetero cyclic compound group, and a condensed cyclic compound group, L₂ is a second ligand, and a ligand used as L₂ can be acetylacetone, 2,2,6,6-tetramethylheptane-3,5-dione, hexafluoropentane-2,4-dione, 1-phenylbutane-1,3-dione, 1,3-diphenylpropane-1,3-dione, or picoline acid, but is not limited to them, and the same ligand as the first ligand may be used)

For example, as a green emitting material, Ir(ppy) 2 (acac) having the following structure can be used.

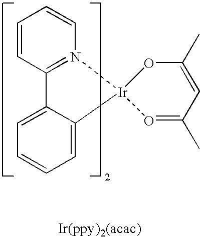

In addition, as a blue emitting material, FIrpic having the following structure can be used.

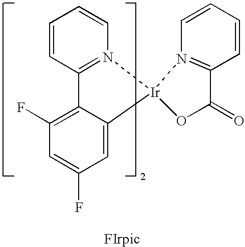

In addition, as a blue emitting material, FIr(acac) having the following structure can be used.

### EXAMPLE 12

### Blue Monolayered Device 6

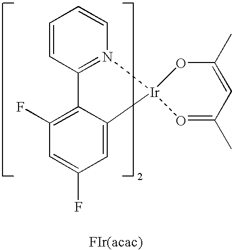

A blue monolayered device 6 was prepared in the same manner as that of Example 2 except that a light emitting layer was formed from a solution of a polymer 1 (PF8-Py) (15 mg), FIr(acac) (1.5 mg) and TPD (9 mg) in chloroform-xylene.

When a voltage was applied to this device, blue color emission from FIr(acac) was shown, and a light emitting peak wavelength was 472 nm. A driving voltage was 6.5V at 10 cd/m², and a maximum luminance was 156 cd/m² (at 10.5V). A light emitting efficiency was 0.11 cd/A (at 7.5V and 32 cd/m²). Like this, in a polymer-based organic electroluminescent device, blue triplet light emission which has been previously difficult can be easily obtained by the method shown in the present application.

### PREPARATION EXAMPLE 3

### Preparation of Polyfluorene-Thiophene (20%) Copolymer [PF8-Th (20%)]

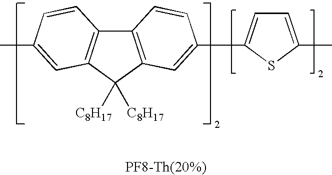

A reaction apparatus equipped with a stirring device was dried well, and was connected to a nitrogen/vacuum line. 2,5-dibromothiophene (48.4 mg, 0.2 mmol), 9,9-dioctylfluorene-2,7-dibromide (164.4 mg, 0.3 mmol), 9,9-dioctylfluorene-2,7-bis(4,4,5,5-tetramethyl-1,3,2-dioxa borolane) (321 mg, 0.5 mmol), Suzuki coupling catalyst, toluene (5 ml), and an aqueous basic solution (8 ml) were added to a reactor. An opening part of the reactor was closed with a rubber plug, evacuation and nitrogen purging for a short time were repeated three times, and replacement of the air in the reactor with nitrogen and degassing of a solvent were performed. Thereafter, the reactor was heated to 90° C., and a reaction was performed for about 3 hours while maintaining at 90° C. under the nitrogen atmosphere. Thereafter, phenylboronic acid (61 mg, 0.5 mmol) was added to the reaction solution, and a reaction was further performed at 90° C. for 2 hours under the nitrogen atmosphere. Thereafter, bromobenzene (0.12 ml, 1.1 mmol) was added to the reaction solution, and a reaction was further performed at 90° C. for 2 hours under the nitrogen atmosphere. After completion of the reaction, the reaction solution was cooled to room temperature, and added dropwise to methanol (300 ml) to precipitate a polymer product. The polymer product was washed with methanol three times, and then dried in vacuum. Thereafter, a polymer product was dissolved in about 10 ml of toluene, and the solution was passed through a short column using silica gel, employing toluene as an extraction liquid to remove impurities The solution which had passed through a column was concentrated using a rotary evaporator, and then a polymer solution was added dropwise to methanol (300 ml) while methanol was stirred, to precipitate again a polymer product. The polymer product was washed with methanol three times, and then vacuum-dried to obtain the final product. The final product was a gray-white powdery polymer. A synthesis yield was about 84%. Results of measurement of a molecular weight by GPC were as follows: in terms of polystyrene, a number average molecular weight Mn was 42,000, a weight average molecular weight Mw was 110,000, and Mw/Mn was 2.62.

### PREPARATION EXAMPLE 4

### Preparation of Polyfluorene-Diamine (30%)-Pyridine (20%) Copolymer [PF8-tBuTPD(30%)-Py(20%)]

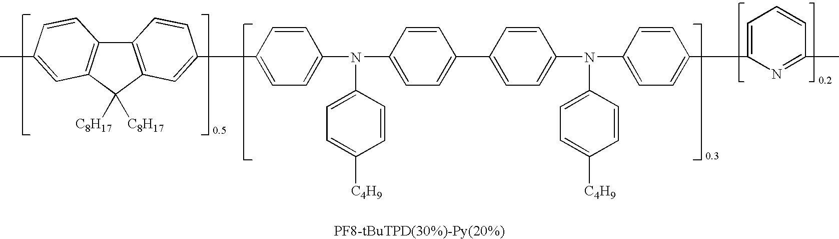

A reaction apparatus equipped with a stirring device was dried well, and connected to a nitrogen/vacuum line. 2,6-dibromopyridine (47.4 mg, 0.2 mmol), N,N′-bis(4-bromophenyl)-N,N′-bis(4-tert-butylphenyl)-benzidine (227.4 mg, 0.3 mmol), 9,9-dioctylfluorene-2,7-bis(4,4,5,5-tetramethyl-1,3,2-dioxa borolane) (321 mg, 0.5 mmol), Suzuki coupling catalyst, toluene (5 ml), and an aqueous basic solution (8 ml) were added to a reactor. An opening part of the reactor was closed with a rubber plug, evacuation and nitrogen purging for a short time were repeated three times, and replacement of the air in the reactor with nitrogen and degassing of a solvent were performed. Thereafter, the reactor was heated to 90° C., and a reaction was performed for about 3 hours while retaining at 90° C. under the nitrogen atmosphere. Thereafter, phenylboronic acid (61 mg, 0. 5 mmol) was added to the reaction solution, and a reaction was further performed at 90° C. for 2 hours under the nitrogen atmosphere. Thereafter, bromobenzene (0.12 ml, 1.1 mmol) was added to the reaction solution, and a reaction was further performed at 90° C. for 2 hours under the nitrogen atmosphere. After completion of the reaction, the reaction solution was cooled to room temperature, and added dropwise to methanol (300 ml) to precipitate a polymer product. The polymer product was washed with methanol three times, and then dried in vacuum. Thereafter, a polymer product was dissolved in about 10 ml of toluene, and the solution was passed through a short column using silica gel, employing toluene as an extraction liquid, to remove impurities. The solution which had passed through a column was concentrated using a rotary evaporator, and the polymer solution was added dropwise to methanol (300 ml) while methanol was stirred, to precipitate a polymer product again. The polymer product was washed with methanol three times, and then vacuum-dried to obtain the final product. The final product was a gray-white fiber-like polymer. A synthesis yield was about 90%. Results of measurement of a molecular weight by GPC were as follows: in terms of styrene, a number average molecular weight Mn was 83,000, a weight average molecular weight Mw was 180,000, and Mw/Mn was 2.17.

### COMPARATIVE PREPARATION EXAMPLE 2

### Preparation of Polyfluorene-Diamine Alternate Copolymer [PF8-tBuTPD]

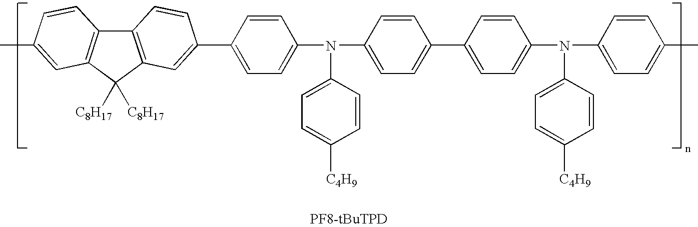

A reaction apparatus equipped with a stirring device was dried well, and connected to a nitrogen/vacuum line. N,N′-bis(4-bromophenyl)-N,N′-bis(4-tert-butylphenyl)-benzidine (379 mg, 0.5 mmol), 9,9-dioctylfluorene-2,7-bis(4,4,5,5-tetramethyl-1,3,2-dioxa borolane) (321 mg, 0.5 mmol), Suzuki coupling catalyst, toluene (5 ml), and an aqueous basic solution (8 ml) were added to a reactor. An opening part of the reactor was closed with a rubber plug, evacuation and nitrogen purging for a short time were repeated three times, and replacement of the air in the reactor with nitrogen and degassing of a solvent were performed. Thereafter, the reactor was heated to 90° C., and a reaction was performed for about 3 hours while retaining at 90° C. under the nitrogen atmosphere. Thereafter, phenylboronic acid (61 mg, 0.5 mmol) was added to the reaction solution, and a reaction was further performed at 90° C. for 2 hours under the nitrogen atmosphere. Thereafter, bromobenzene (0.12 ml, 1.1 mmol) was added to the reaction solution, and a reaction was further performed at 90° C. for 2 hours under the nitrogen atmosphere. After completion of the reaction, the reaction solution was cooled to room temperature, and was added dropwise to methanol (300 ml) to precipitate a polymer product. A polymer product was washed with methanol three times, and then dried in vacuum. Thereafter, a polymer product was dissolved in about 10 ml of toluene, the solution was passed through a short column using silica gel, employing toluene as an extraction liquid, to remove impurities. The solution which had passed through a column was concentrated using a rotary evaporator, and the polymer solution was added dropwise to methanol (300 ml) while methanol was stirred, to precipitate a polymer product again. The polymer product was washed with methanol three times, and then vacuum-dried to obtain the final product. The final product was a gray-white fiber-like polymer. A synthesis yield was about 92%. Results of measurement of a molecular weight by GPC were as follows: in terms of styrene, a number average molecular weight Mn was 62,000, a weight average molecular weight Mw was 230,000, and Mw/Mn was 3.70.

### PREPARATION EXAMPLE 5

### Preparation of Polyfluorene-Diamine (40%)-Cyclohexylthiophene (10%) Copolymer [PF8-tBuTPD(40%) -CyTh(10)]

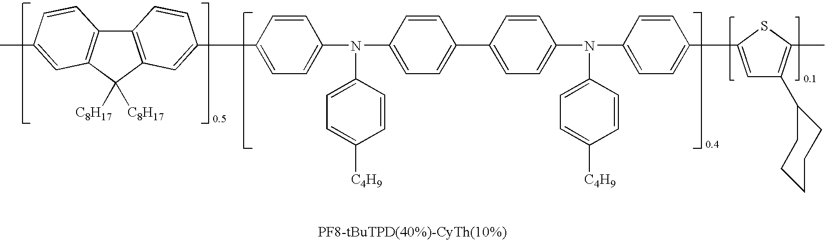

A reaction apparatus equipped with a stirring apparatus was dried well, and connected to a nitrogen/vacuum line. 2,5-dibromo-3-cyclohexylthiophene (32.4 mg, 0.1 mmol), N,N′-bis(4-bromophenyl)-N,N′-bis(4-tert-butylphenyl)-benzidine (303.2 mg, 0.4 mmol), 9,9-dioctylfluorene-2,7-bis(4,4,5,5-tetramethyl-1,3,2-dioxa borolane) (321 mg; 0.5 mmol), Suzuki coupling catalyst, toluene (5 ml), and an aqueous basic solution (8 ml) were added to a reactor. An opening part of the reactor was closed with a rubber plug, evacuation and nitrogen purging for a short time were repeated three times, and replacement of the air in the reactor with nitrogen and degassing of a solvent were performed. Thereafter, the reactor was heated to 90° C., and a reaction was performed for about 3 hours while retaining at 90° C. under the nitrogen atmosphere. Thereafter, phenylboronic acid (61 mg, 0.5 mmol) was added to the reaction solution, and a reaction was further performed at 90° C. for 2 hours under the nitrogen atmosphere. Thereafter, bromobenzene (0.12 ml, 1.1 mmol) was added to the reaction solution, and a reaction was further performed at 90° C. for 2 hours under the nitrogen atmosphere. After completion of the reaction, the reaction solution was cooled to room temperature, and added dropwise to methanol (300 ml) to precipitate a polymer product. The polymer product was washed with methanol three times, and then dried in vacuum. Thereafter, a polymer product was dissolved in about 10 ml of toluene, and the solution was passed through a short column using silica gel, employing toluene as an extraction liquid, to remove impurities. The solution which had passed through a column was concentrated using a rotary evaporator, and the polymer solution was added dropwise to methanol (300 ml) while methanol was stirred, to precipitate a polymer product again. The polymer product was washed with methanol three times, and then vacuum-dried to obtain the final product. The final product was a green-white powdery polymer. A synthesis yield was about 90%. Results of measurement of a molecular weight by GPC were as follows: in terms of polystyrene, a number average molecular weight Mn was 32,000, a weight average molecular weight Mw was 76,000, and Mw/Mn was 2.38.

### PREPARATION EXAMPLE 6

### Preparation of Polyfluorene-Diamine (30%)-Thiophene (20%) Copolymer [PF8-tBuTPD(30%)-Th(20%)]

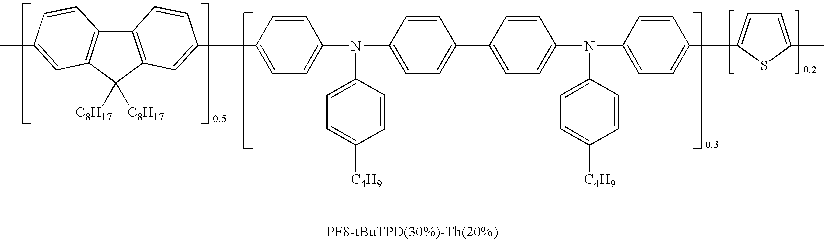

A reaction apparatus equipped with a stirring device was dried well, and connected to a nitrogen/vacuum line. 2,6-dibromothiophene (48.4 mg, 0.2 mmol), N,N′-bis(4-bromophenyl)-N,N′-bis(4-tert-butylphenyl)-benzidine (227.4 mg, 0.3 mmol), 9,9-dioctylfluorene-2,7-bis(4,4,5,5-tetramethyl-1,3,2-dioxa borolane) (321 mg, 0.5 mmol), Suzuki coupling catalyst, toluene (5 ml), and an aqueous basic solution (8 ml) were added to a reactor. An opening part of the reactor was closed with a rubber plug, evacuation and nitrogen purging for a short time were repeated three times, and replacement of the air in the reactor with nitrogen and degassing of a solvent were performed. Thereafter, the reactor was heated to 90° C., and a reaction was performed for about 3 hours while retaining at 90° C. under the nitrogen atmosphere. Thereafter, phenylboronic acid (61 mg, 0.5 mmol) was added to the reaction solution, and a reaction was further performed at 90° C. for 2 hours under the nitrogen atmosphere. Thereafter, bromobenzene (0.12 ml, 1.1 mmol) was added to the reaction solution, and a reaction was further performed at 90° C. for 2 hours under the nitrogen atmosphere. After completion of the reaction, the reaction solution was cooled to room temperature, and added dropwise to methanol (300 ml) to precipitate a polymer product. The polymer product was washed with methanol three times, and then dried in vacuum. Thereafter, a polymer product was dissolved in about 10 ml of toluene, and the solution was passed through a short column using a silica gel, employing toluene as an extraction liquid, to remove impurities. The solution which had passed through a column was concentrated using a rotary evaporator, and the polymer solution was added dropwise to methanol (300 ml) while methanol was stirred, to precipitate a polymer product again. The polymer product was washed with methanol three times, and then vacuum-dried to obtain the final product. The final product was a gray-white powdery polymer. A synthesis yield was about 82%. Results of measurement of a molecular weight by GPC were as follows: in terms of polystyrene, a number average molecular weight Mn was 32,000, a weight average molecular weight Mw was 84,000, and Mw/Mn was 2.63.

### PREPARATION EXAMPLE 7

### Preparation of Polyphenylene-Pyridine Alternate Copolymer [PPOC10-Py]>

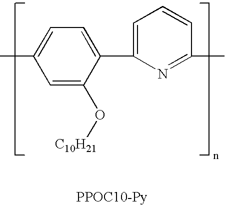

A reaction apparatus equipped with a stirring device was dried well, and connected to a nitrogen/vacuum line. 1,4-bis(4,4,5,5-tetramethyl-1,3,2-dioxaborolanyl)-2-desilox ybenzene (243 mg, 0.5 mmol), 2,6-dibromopyridine (118 mg, 0.5 mmol), Suzuki coupling catalyst, toluene (5 ml), and an aqueous basic solution (8 ml) were added to a reactor. An opening part of the reactor was closed with a rubber plug, evacuation and nitrogen purging for a short time were repeated three times, replacement of the air in the reactor with nitrogen and degassing of a solvent were performed. Thereafter, the reactor was heated to 90° C., and a reaction was performed for about 3 hours while retaining at 90° C. under the nitrogen atmosphere. Thereafter, phenylboronic acid (61 mg, 0.5 mmol) was added to the reaction solution, and a reaction was further performed at 90° C. for 2 hours under the nitrogen atmosphere. Thereafter, bromobenzene (0.12 ml, 1.1 mmol) was added to the reaction solution, and a reaction was further performed at 90° C. for 2 hours under the nitrogen atmosphere. After completion of the reaction, the reaction solution was cooled to room temperature, and added dropwise to methanol (300 ml) to precipitate a polymer product. The polymer product was washed with methanol three times, and then dried in vacuum. Thereafter, a polymer product was dissolved in about 10 ml of toluene, and the solution was passed through a short column using silica gel, employing toluene as an extraction liquid, to remove impurities. The solution which had passed through a column was concentrated using a rotary evaporator, and the polymer solution was added dropwise to methanol (300 ml) while methanol was stirred, to precipitate a polymer product again. The polymer product was washed with methanol three times, and then vacuum-dried to obtain the final product. The final product was white powdery polymer. A synthesis yield was about 85%. Results of measurement of a molecular weight by GPC were as follows: in terms of styrene, a number average molecular weight Mn was 55,000, a weight average molecular weight Mw was 140,000, and Mw/Mn was 2.55.

### COMPARATIVE PREPARATION EXAMPLE 3

### Preparation of Polyphenylene [PPOC10]

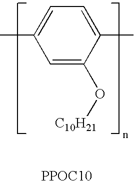

A reaction apparatus equipped with a stirring device was dried well, and connected to a nitrogen/vacuum line. 1,4-bis(4,4,5,5-tetramethyl-1,3,2-dioxaborolanyl)-2-desilox ybenzene (243 mg, 0.5 mmol), 1,4-dibromo-2-desiloxybenzene (196 mg, 0.5 mmol), Suzuki coupling catalyst, toluene (5 ml), and an aqueous basic solution (8 ml) were added to a reactor. An opening part of the reactor was closed with a rubber plug, evacuation and nitrogen purging for a short time were performed three times, and replacement of the air in the reactor with nitrogen and degassing of a solvent were performed. Thereafter, the reactor was heated to 90° C., and a reaction was performed for about 3 hours while retaining at 90° C. under the nitrogen atmosphere. Thereafter, phenylboronic acid (61 mg, 0.5 mmol) was added to the reaction solution, and a reaction was further performed at 90° C. for 2 hours under the nitrogen atmosphere. Thereafter, bromobenzene (0.12 ml, 1.1 mmol) was added to the reaction solution, and a reaction was further performed at 90° C. for 2 hours under the nitrogen atmosphere. After completion of the reaction, the reaction solution was cooled to room temperature, and added dropwise to methanol (300 ml) to precipitate a polymer product. The polymer product was washed with methanol three times, and then dried in vacuum. Thereafter, a polymer product was dissolved in about 10 ml of toluene, the solution was passed through a short column using a silica gel, employing toluene as an extraction liquid, to remove impurities. The solution which had passed through a column was concentrated using a rotary evaporator, and the polymer solution was added dropwise to methanol (300 ml) while methanol was stirred, to precipitate a polymer product again. The polymer product was washed with methanol three times, and then vacuum-dried to obtain the final product. The final product was a white powdery polymer. A synthesis yield was about 88%. Results of measurement of a molecular weight by GPC were as follows: in terms of polystyrene, a number average molecular weight Mn was 70,000, a weight average molecular weight Mw was 180,000, and Mw/Mn was 2.57.

### PREPARATION EXAMPLE 8

### Preparation of Polyphenylene-Diamine (30%)-Pyridine (20%) Copolymer [PPOC10-tBuTPD(30%) -Py(20%)]

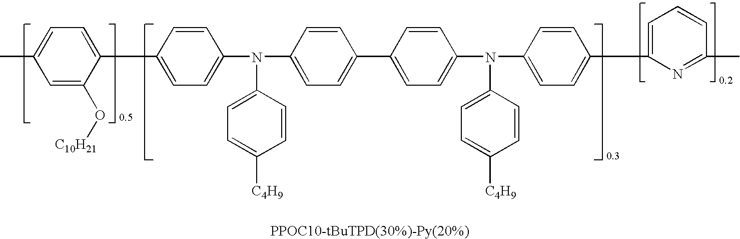

A reaction apparatus equipped with a stirring device was dried well, and connected to a nitrogen/vacuum line. 2,6-dibromopyridine (47.4 mg, 0.2 mmol), N,N′-bis(4-bromophenyl)-N,N′-bis(4-tert-butylphenyl)-benzidine (227.4 mg, 0.3 mmol), 1,4-bis(4,4,5,5-tetramethyl-1,3,2-dioxaborolanyl)-2-desilox ybenzene (243 mg, 0.5 mmol), Suzuki coupling catalyst, toluene (5 ml), and an aqueous basic solution (8 ml) were added to a reactor. An opening part of the reactor was closed with a rubber plug, evacuation and nitrogen purging for a short time were repeated three times, and replacement of the air in the reactor with nitrogen and degassing of a solvent were performed. Thereafter, the reactor was heated to 90° C., and a reaction was performed for about 3 hours while retaining at 90° C. under the nitrogen atmosphere. Thereafter, phenylboronic acid (61 mg, 0.5 mmol) was added to the reaction solution, and a reaction was further performed at 90° C. for 2 hours under the nitrogen atmosphere. Thereafter, bromobenzene (0.12 ml, 1.1 mmol) was added to the reaction solution, and a reaction was further performed at 90° C. for 2 hours under the nitrogen atmosphere. After completion of the reaction, the reaction solution was cooled to room temperature, and added dropwise to methanol (300 ml) to precipitate a polymer product. The polymer product was washed with methanol three times, and then dried in vacuum. Thereafter, a polymer product was dissolved in about 10 ml of toluene, and the solution was passed through a short column using silica gel, employing toluene as an extraction liquid, to remove impurities. The solution which had passed though a column was concentrated using a rotary evaporator, and the polymer solution was added dropwise to methanol (300 ml) while methanol was stirred, to precipitate a polymer product again. The polymer product was washed with methanol three times, and then vacuum-dried to obtain the final product. The final product was a white powdery polymer. A synthesis yield was about 80%. Results of measurement of a molecular weight by GPC were as follows: in terms of polystyrene, a number average molecular weight Mn was 35,000, a weight average molecular weight Mw was 110,000, and Mw/Mn was 3.14.

### PREPARATION EXAMPLE 9

### Preparation of Polyphenylene-Diamine Alternate Copolymer [PPOC10-tBuTPD]

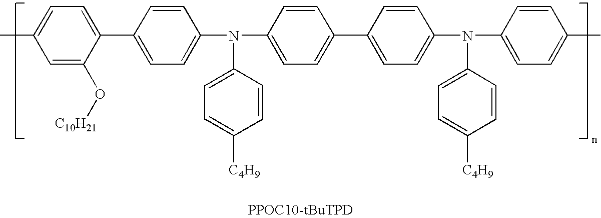

A reaction apparatus equipped with a stirring device was dried well, and connected to a nitrogen/vacuum line. N,N′-bis(4-bromophenyl)-N,N′-bis(4-tert-butylphenyl)benzidine (379 mg, 0.5 mmol), 1,4-bis(4,4,5,5-tetramethyl-1,3,2-dioxaborolanyl)-2-desilox ybenzene (243 mg, 0.5 mmol), Suzuki coupling catalyst, toluene (5 ml), and an aqueous basic solution (8 ml) were added to a reactor. An opening part of the reactor was closed with a rubber plug, evacuation and nitrogen purging for a short time were repeated three times, and replacement of the air in the reactor with nitrogen and degassing of a solvent were performed. Thereafter, the reactor was heated to 90° C., and a reaction was performed for about 3 hours while retaining at 90° C. under the nitrogen atmosphere. Thereafter, phenylboronic acid (61 mg, 0. 5 mmol) was added to the reaction solution, and a reaction was further performed at 90° C. for 2 hours under the nitrogen atmosphere. Thereafter, bromobenzene (0.12 ml, 1.1 mmol) was added to the reaction solution and a reaction was further performed at 90° C. for 2 hours under the nitrogen atmosphere. After completion of the reaction, the reaction solution was cooled to room temperature, and added dropwise to methanol (300 ml) to precipitate a polymer product. The polymer product was washed with methanol three times, and then dried in vacuum. Thereafter, the polymer product was dissolved in about 10 ml of toluene, and the solution was passed through a short column using silica gel, employing toluene as an extraction liquid, to remove impurities. The solution which had passed through a column was concentrated using a rotary evaporator, and the polymer solution was added dropwise to methanol (300 ml) while methanol was stirred, to precipitate a polymer product again. The polymer product was washed with methanol three times, and then vacuum-dried to obtain a final product. The final product was a white powdery polymer. A synthesis yield was about 82%. Results of measurement of a molecular weight by GPC were as follows: in terms of polystyrene, a number average molecular weight Mn was 45000, a weight average molecular weight Mw was 140000, and Mw/Mn was 3.11.

### EXAMPLE 13

### Triplet Red Emitting Device Using Host Polymer [PF8-Th (20%)]

Indium tin oxide (ITO) was formed into a film on a glass, an ITO glass substrate in which an ITO film was patterned into a stripe was first ultrasound-washed (10 min) in a detergent solution having a low ion amount, followed by ultrasound-washed two times (each 10 min) while water was replaced in ion-exchanged water. Nitrogen was blown with a nitrogen gun to fly off water droplets on a substrate, and then ultrasound washing was performed in an electronic industry isopropanol, and an electronic industry acetone (each 10 min). The substrate was dried by nitrogen blowing, and ozone-treated with a UV-ozone treating apparatus for 10 minutes. Then, an aqueous solution of a mixture of polyethylenedioxythiophene:polystyrenesulfonic acid (PEDOT:PSS) manufactured by Bayern was passed through a 0.45 μm filter, and spin-coated on the aforementioned ITO glass substrate which had been washed. Rotation under spin-coating conditions of 2,500 rpm and 60 seconds afforded a film thickness of about 500 Å. A PEDOT:PSS film was baked on a hot plate at 20° C. for 10 minutes in the air and, thereafter, baked in a vacuum baking oven at 80° C. for 30 minutes, to completely remove a remaining moisture.

As a solution for forming a light emitting layer, a solution was prepared by dissolving a polymer material PF8-Th (20 mg), and a triplet emitting material btp₂Ir (acac) (2 mg) in a chloroform-xylene mixed solvent (1 ml:2 ml), and passing the solution through a 0.2 μm filter. The solution was spin-coated on the PEDOT:PSS film to make a film of a light emitting layer. Rotation for 60 seconds under spin coating conditions of 2000 rpm afforded a film thickness of about 800 Å. Using a metal shadow mask, an electrode was deposited thereon so as to cross with a stripe of ITO at a right angle. As an electrode, calcium (thickness 50 Å) and aluminum (thickness 2000 Å) were formed into a film in this order. After electrode deposition, a UV curing-type adhesive was coated on an adhesive side of a devise using a glass cap in a glove box purged with nitrogen, and this was sealed by irradiation with UV light (30 seconds) to obtain a device.

### EXAMPLES 14 TO 18 AND COMPARATIVE EXAMPLES 5 TO 9

An organic EL device was prepared in the same manner as that of Example 13 except that a light emitting layer was formed using a host polymer and a light emitting material shown in Table 4.

Ir(ppy)₃ used as a light emitting material has the following structure.

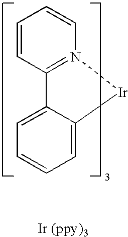

Respective organic EL devices of Example 13 to 18 and Comparative Examples 5 to 9 were driven at a driving voltage shown in Table 4, a maximum luminance (maximum luminance), a light emitting efficiency (maximum efficiency) and CIE chromaticity were measured , and results of measurement are shown in Table 4.

TABLE 4

| | | | | | | Carrier | Driving | | | CIE |
|---|---|---|---|---|---|---|---|---|---|---|
| | Light | Host Polymer | | | | Trans- | Voltage | | | Chro- |
| | Emitting | | First | Second | Third | port | (10 | Maximum | Light Emitting | maticity |
| | Material | Kind | Unit | Unit | Unit | Material | cd/m²) | Luminance | Efficiency | x, y |
| Ex. 13 | btp₂lr(acac) | PF8-Th(20%) | Th | PF8 | — | — | 11 V | 656 cd/m²(at 17.5 V) | 1.15 cd/A (at 220 cd/ | 0.67, 0.31 |
| | | | | | | | | | m²) | |
| Comp. | btp₂lr(acac) | PF8 | — | PF8 | — | — | 12 V | 50 cd/m²(at 15.0 V) | 0.10 cd/A (at 45 cd/ | 0.67, 0.31 |
| Ex. 5 | | | | | | | | | m²) | |
| Ex. 14 | btp₂lr(acac) | PF8- | Py | PF8 | tBuTPD | — | 14.5 V | 150 cd/m²(at 20.0 V) | 0.50 cd/A (at 100 cd/ | 0.67, 0.32 |
| | | tBuTPD(30%)- | | | | | | | m²) | |
| | | Py(20%) | | | | | | | | |
| Comp. | btp₂lr(acac) | PF8-tBuTPD | — | PF8 | tBuTPD | — | 20 V | 11 cd/m²(at 20.5 V) | 0.007 cd/A (at 11 cd/m²) | 0.67, 0.30 |
| Ex. 6 | | | | | | | | | | |
| Ex. 15 | btp₂lr(acac) | PF8- | CyTh | PF8 | tBuTPD | — | 10 V | 25 cd/m²(at 14.0 V) | 0.08 cd/A (at 19 cd/m²) | 0.67, 0.31 |
| | | tBuTPD(40%)- | | | | | | | | |
| | | CyTh(10%) | | | | | | | | |
| Ex. 16 | PtOEP | PF8- | Th | PF8 | tBuTPD | — | 8.5 V | 30 cd/m²(at 11.0 V) | 0.20 cd/A (at 12 cd/m²) | 0.67, 0.32 |
| | | tBuTPD(30%)- | | | | | | | | |
| | | Th(20%) | | | | | | | | |
| Comp. | PtOEP | PF8-tBuTPD | — | PF8 | tBuTPD | — | 10 V | 10 cd/m²(at 10.0 V) | 0.03 cd/A (at 10 cd/m²) | 0.67, 0.32 |
| Ex. 7 | | | | | | | | | | |
| Ex. 17 | lr(ppy)₃ | PPOC10-Py | Py | PPOC10 | — | TPD | 15 V | 350 cd/m²(at 22.0 V) | 1.20 cd/A (at 200 cd/ | 0.29, 0.61 |
| | | | | | | | | | m²) | |
| Comp. | lr(ppy)₃ | PPOC10 | — | PPOC10 | — | TPD | 22 V | 70 cd/m²(at 30.0 V) | 0.20 cd/A (at 50 cd/m²) | 0.29, 0.61 |
| Ex. 8 | | | | | | | | | | |
| Ex. 18 | btp₂lr(acac) | PPOC10- | Py | PPOC10 | tBuTPD | — | 12 V | 140 cd/m²(at 20.0 V) | 0.50 cd/A (at 100 cd/ | 0.67, 0.31 |
| | | tBuTPD(30%)- | | | | | | | m²) | |
| | | Py(20%) | | | | | | | | |
| Comp. | btp₂lr(acac) | PPOC10- | — | PPOC10 | tBuTPD | — | 11 V | 20 cd/m²(at 14.0 V) | 0.02 cd/A (at 20 cd/m²) | 0.67, 0.31 |
| Ex. 9 | | tBuTPD | | | | | | | | |

As apparent from results shown in Table 4, respective organic EL devices of Examples 13 to 18 in accordance with the present invention show higher maximum luminance and light emitting efficiency as compared with respective organic EL devices of Comparative Examples 5 to 9.

1. An organic electroluminescent device comprising a light emitting layer disposed between a pair of electrodes, wherein the light emitting layer contains a light emitting material, and a host polymer having a first unit having a pyridine ring or a thiophene ring interacting with the light emitting material so that energy can be transferred to the light emitting material, and a second unit having a conjugated or non-conjugated structure.

2. The organic electroluminescent device according to claim 1, wherein the second unit has carrier transport property.

3. The organic electroluminescent device according to claim 1, wherein a site interacting with the light emitting material in the first unit is nitrogen, phosphorus, sulfur or oxygen.

4. The organic electroluminescent device according to claim 1, wherein the conjugated structure of the second unit is a structure containing fluorene.

5. The organic electroluminescent device according to claim 1, wherein the conjugated structure in the second unit is a structure containing phenylene.

6. The organic electroluminescent device according to claim 1, wherein the conjugated structure in the second unit is a structure containing phenylamine.

7. The organic electroluminescent device according to claim 1, wherein the light emitting material is a metal complex.

8. The organic electroluminescent device according to claim 7, wherein the metal complex is an Ir complex, a Pt complex, an Al complex, a Zn complex or an Os complex.

9. The organic electroluminescent device according to claim 7, wherein the metal complex has one or two or more kinds of chelate ligands.

10. The organic electroluminescent device according to claim 7, wherein the metal complex is a phosphorescent material.

11. The organic electroluminescent device according to claim 1, wherein the light emitting layer further contains a carrier transport material for improving carrier transport property.

12. The organic electroluminescent device according to claim 1, wherein the host polymer further has a third unit.

13. The organic electroluminescent device according to claim 12, wherein the third unit has carrier transport property for taking balance on carrier transport property of the first unit and/or the second unit.

14. The organic electroluminescent device according to claim 1, wherein the light emitting layer is formed by coating a solution in which the light emitting material, the host polymer and, if necessary, the carrier transport material have been dissolved.
